(19) United States
(12) Patent Application Publication
(10) Pub. No.: US 2004/0212561 A1
(43) Pub. Date: Oct. 28, 2004

(54) Semiconductor integrated circuit device

(76) Inventors: Katsuhisa Matsuda, Takasaki (JP); Fumihito Hayashi, Misato (JP); Isao Tagaya, Isesaki (JP)

Correspondence Address: Mattingly, Stanger & Malur, P.C., Suite 370, 1800 Diagonal Road, Alexandria, VA, 22314, US

(21) Appl. No.: 10/812,934

(22) Filed: Mar. 31, 2004

(30) Foreign Application Priority Data
Apr. 24, 2003 (JP) 2003-119303

(51) Int. Cl. G09G 3/28; G09G 3/10

(52) U.S. Cl. 345/60; 315/169.4

(57) ABSTRACT

Disclosed here is a method for improving drivability and reduce power consumption in such a display device as a plasma display device. An address electrode driving circuit provided in a plasma display panel display device includes a driving pulse generation circuit, as well as a plurality of address electrode driving parts. In each of the address electrode driving parts, a latch latches a preceding pulse output from another latch, then inputs the pulse to an exclusive OR circuit together with a new pulse output from the other latch. A NAND-circuit outputs a drive pulse/ACL only when those pulses change. Consequently, when a shift register outputs signals without changing a signal level, for example, from a High signal to a High signal or from a Low signal to a Low signal, no drive pulse/ACL is output, thereby wasteful drive current consumption is prevented.

### CROSS-REFERENCE TO RELATED APPLICATION

The present application claims priority from Japanese patent application JP 2003-119303 filed on Apr. 24, 2003, the content of which is hereby incorporated by reference into this application.

### BACKGROUND OF THE INVENTION

The present invention relates to a driving technique for display devices, more particularly to a technique to be employed effectively to reduce power consumption and size of such devices as plasma display devices.

An address electrode driving part is usually provided in each of such display devices as plasma display panels and the address electrode driving part is configured by a plurality of one-chip address driving semiconductor integrated circuit devices.

This address electrode driving part drives address electrodes of an object plasma display panel according to display data output from a frame memory. Each of the address electrode driving semiconductor integrated circuit devices is configured by a shift register, a latch circuit, an output circuit, etc. The output circuit is configured by a level shifter, a buffer, an output driver, etc.

The display data output from the frame memory is supplied to the shift register sequentially to be translated into parallel data by the shift register, then output to the latch circuit.

The latch circuit latches data output from the shift register according to a latch signal and outputs the latched data to the output circuit. The latched data is then supplied to both of the level shifter and the buffer respectively corresponding to itself, then output to the output driver configured by P-channel MOS transistors and N-channel MOS transistors from those level shifter and buffer so as to turn ON/OFF the output driver.

The output voltage of the output driver is applied to the object plasma display panel as address pulses for driving the address electrodes of the plasma display panel.

In the plasma display panel, the power consumption is reduced by the following technique. The technique, for example, provides the address electrode driving part with a delay circuit so that the delay circuit is turned on/off during addressing operations at line selection cycles to delay control signals so as to prevent the power supply from short-circuiting, thereby reducing the redundant power consumption related to the electrostatic capacity between data electrodes used to select one of the data electrode arrays disposed in the form of a matrix in the plasma display panel (refer to the patent document 1).

[Patent Document 1]

Japanese Unexamined Patent Publication No. 2000-172215

### SUMMARY OF THE INVENTION

In such a circuit configuration of the above semiconductor integrated circuit device, however, the inventors of the present invention have found that the following problems will occur.

Concretely, because the voltage amplitude of the output driver comes to take a value of high supply voltage—reference potential (VSS), the gate-source voltage Vgs of the P-channel MOS transistor of the output driver is required to have a withstand voltage higher than that of the applied high supply voltage.

And, in order to obtain such a high withstand voltage of the gate-source voltage Vgs, the transistor oxide film is required to be thicker and this increases the on-resistance of the output driver.

Consequently, the layout area of the P-channel MOS transistor is required to be increased, thereby the area of the semiconductor chip increases, resulting in an increase of the manufacturing cost.

Furthermore, because the gate oxide film is required to be thicker only in the P-channel MOS transistor of the output driver, the manufacturing cost might increase. Even in this process technique, it is more difficult to increase the withstand voltage of the gate-source voltage Vgs than to increase the withstand voltage of the drain-source voltage Vds of the P-channel MOS transistor.

Furthermore, because the P-channel MOS transistor of the output driver is driven by a voltage as described above, the on-resistance variation of the P-channel MOS transistor also increases due to a variation of the high supply voltage and the variation of the rising speed caused by a load current comes to increase. This has been another conventional problem.

Under such circumstances, it is an object of the present invention to provide a semiconductor integrated circuit device that can improve the drivability and reduce the through-current significantly, thereby both of the power consumption and the size of a display device such as a plasma display are reduced.

The above and further objects and novel features of the present invention will appear more fully from the following description and accompanying drawings.

Typical objects of the present invention to be disclosed in this specification will be described briefly as follows.

The semiconductor integrated circuit device of the present invention in one aspect includes a driving control part configured by an output part for outputting an electrode driving pulse for driving an address electrode of a display device according to a first change-over signal, a second change-over signal, and a driving pulse and an output driving part for driving the output part according to display data. The output driving part outputs the driving pulse for driving the output part when the first data inputted first and the second data inputted after the input of the first data change. Both first and second data are included in the above described display data.

Next, the semiconductor integrated circuit device of the present invention in other aspects will be described briefly.

The semiconductor integrated circuit device of the present invention in another aspect includes a driving control part configured by an output part for outputting an electrode driving pulse for driving an address electrode of a display device and an output driving part for driving the output part according to display data. The output driving part includes a high impedance driving pulse generation part for outputting a high impedance pulse for driving the output of the output part into a high impedance state according to a high impedance control signal when an output of the output part is changed over.

### BRIEF DESCRIPTION OF THE DRAWINGS

FIG. 1 is a block diagram of a major portion of a plasma display panel display device in an embodiment of the present invention;

FIG. 2 is a block diagram of an address electrode driving circuit provided in the plasma display panel display device shown in FIG. 1;

FIG. 3 is a circuit diagram of an output circuit provided in the address electrode driving circuit shown in FIG. 2;

FIG. 4 is a timing chart of each part signal in the address electrode driving circuit shown in FIG. 2;

FIG. 5 is a block diagram of the address electrode driving circuit shown in FIG. 2 in an example;

FIG. 6 is a timing chart of each part signal in the address electrode driving circuit shown in FIG. 5;

FIG. 7 is a block diagram of the address electrode driving circuit shown in FIG. 2 in another example;

FIG. 8 is a timing chart of each part signal in the address electrode driving circuit shown in FIG. 7;

FIG. 9 is a block diagram of the address electrode driving circuit shown in FIG. 7 in still another example;

FIG. 10 is a timing chart of each part signal in the address electrode driving circuit shown in FIG. 9;

FIG. 11 is a block diagram of the address electrode driving circuit provided in a plasma display panel in another embodiment of the present invention; and

FIG. 12 is a timing chart of each part signal in the address electrode driving circuit shown in FIG. 11.

### DETAILED DESCRIPTION OF THE PREFERRED EMBODIMENT

Hereunder, the preferred embodiment of the present invention will be described with reference to the accompanying drawings.

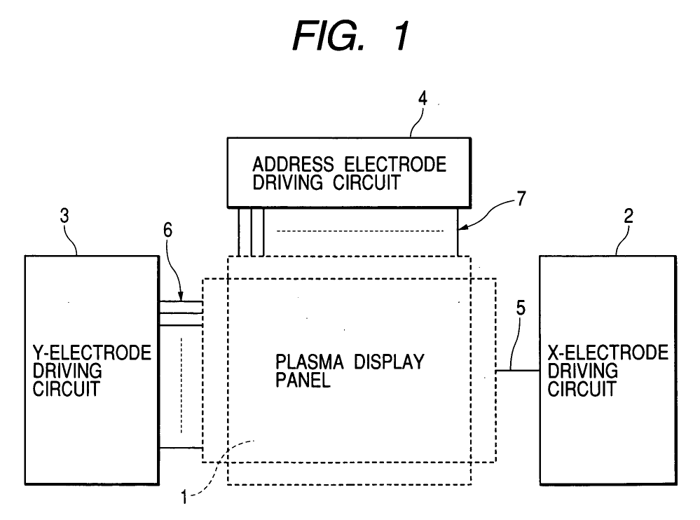

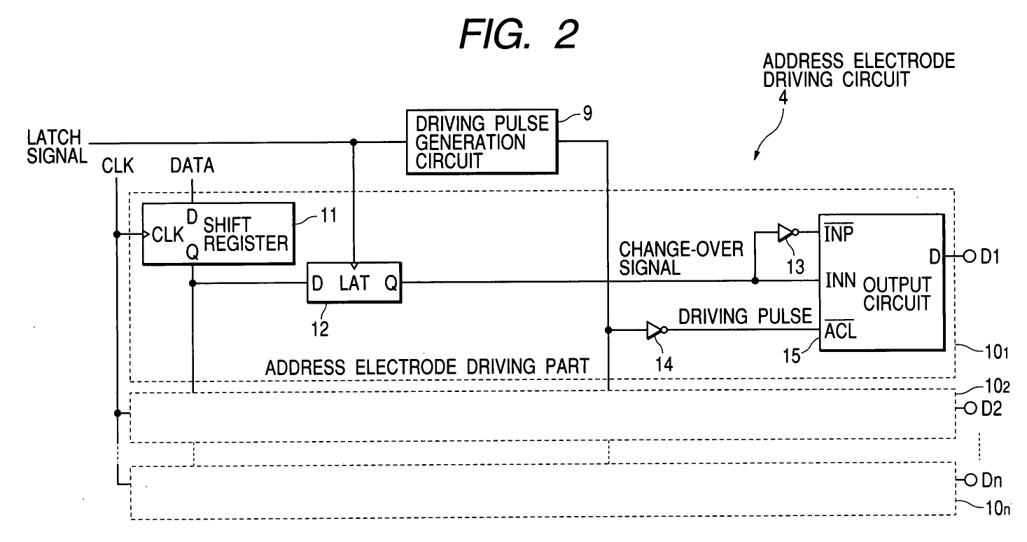

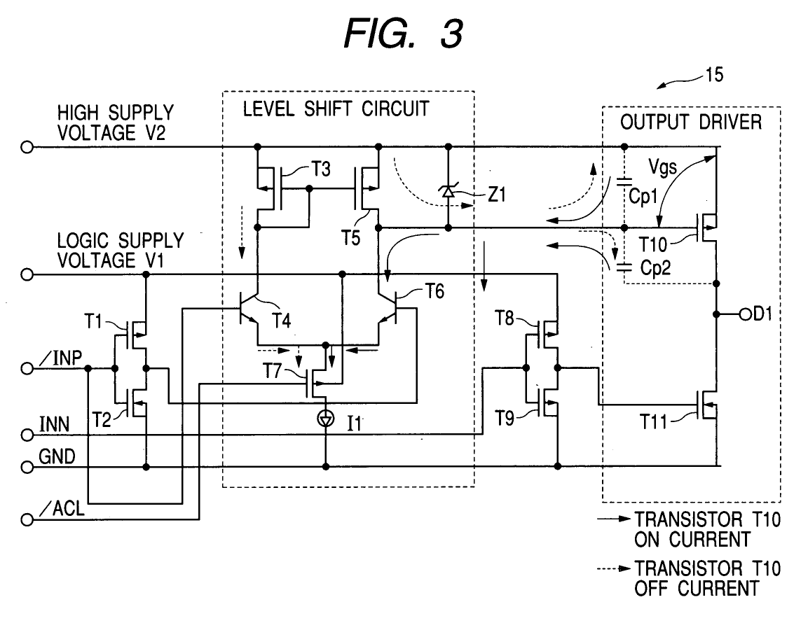

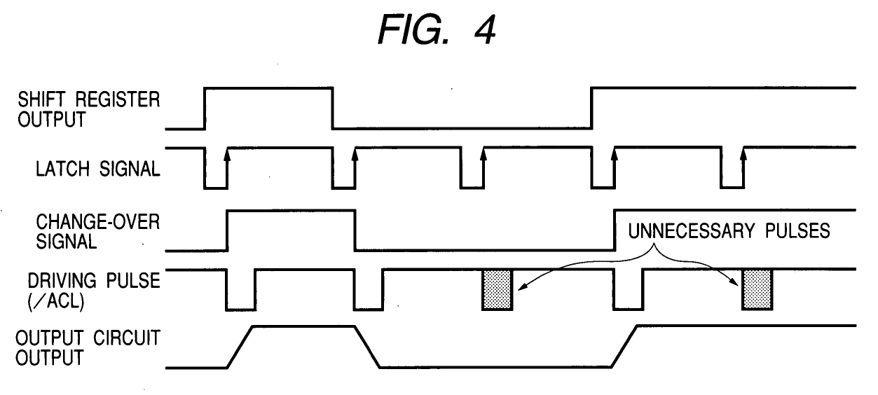

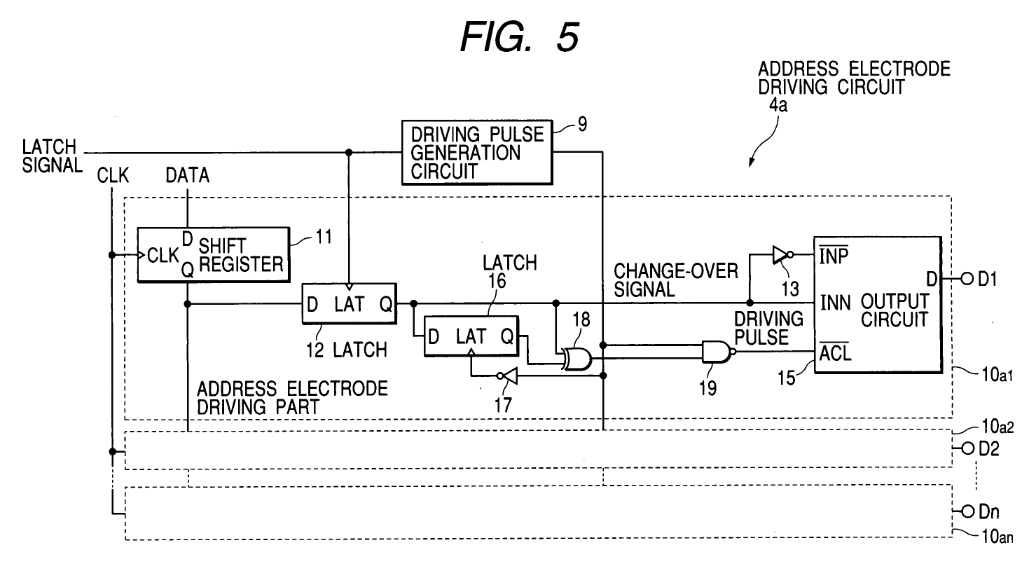

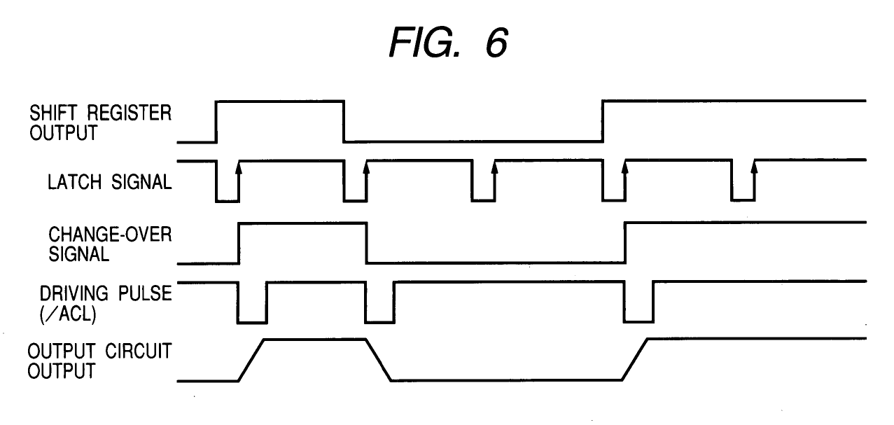

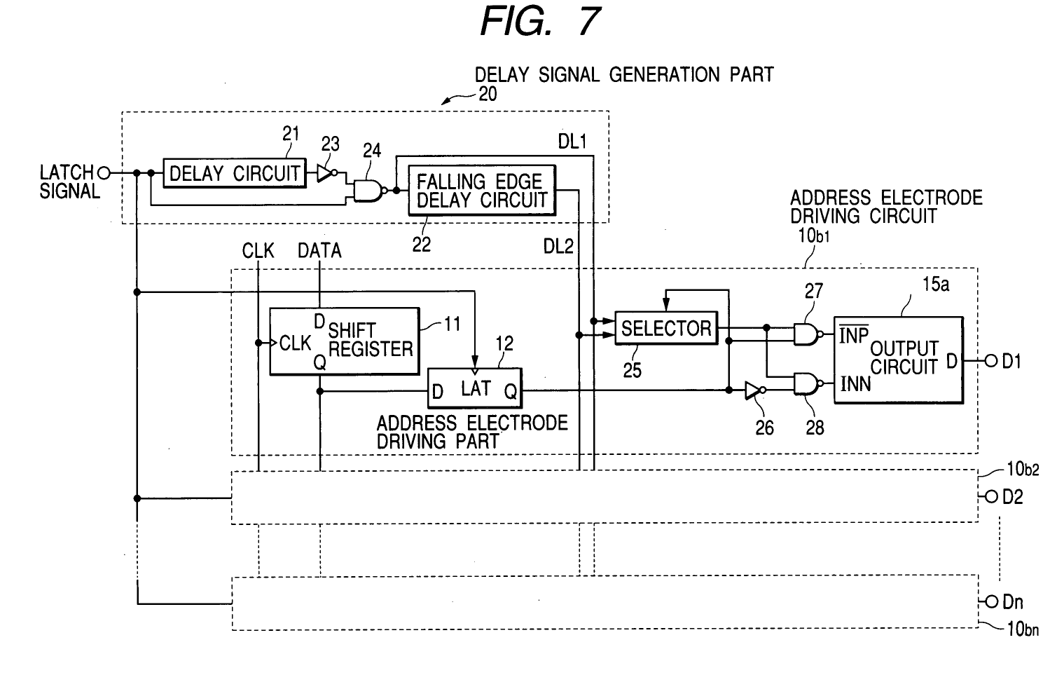

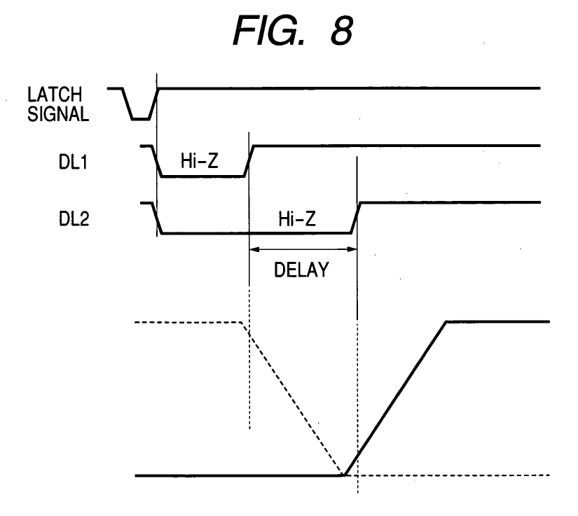

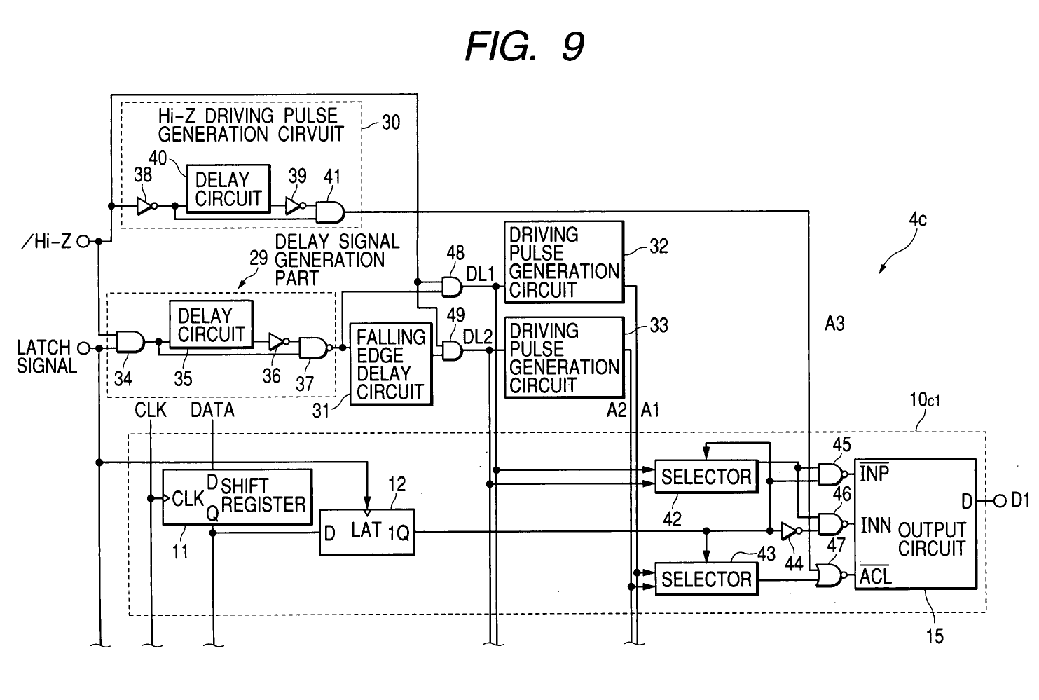

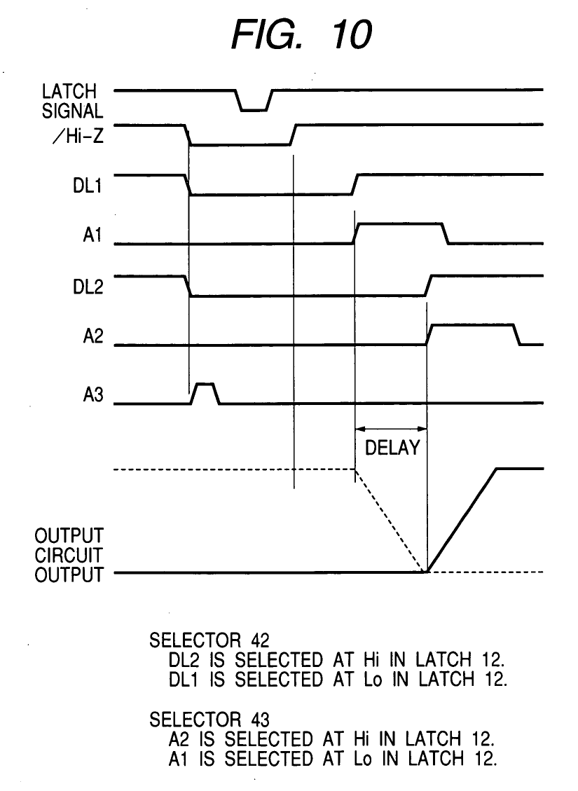

FIG. 1 shows a block diagram of a major portion of a plasma display panel display device in an embodiment of the present invention. FIG. 2 shows a block diagram of an address electrode driving circuit provided in the plasma display panel display device shown in FIG. 1. FIG. 3 is a circuit diagram of an output circuit provided in the address electrode driving circuit shown in FIG. 2. FIG. 4 shows a timing chart of each part signal in the address electrode driving circuit shown in FIG. 2. FIG. 5 shows a block diagram of the address electrode driving circuit shown in FIG. 2 in an example. FIG. 6 shows a timing chart of each part signal in the address electrode driving circuit shown in FIG. 5. FIG. 7 shows a block diagram of the address electrode driving circuit shown in FIG. 2 in another example. FIG. 8 shows a timing chart of each part signal in the address electrode driving circuit shown in FIG. 7. FIG. 9 shows a block diagram of the address electrode driving circuit shown in FIG. 7 in still another example. FIG. 10 shows a timing chart of each part signal in the address electrode driving circuit shown in FIG. 9.

In this embodiment, the plasma display panel display device, as shown in FIG. 1, comprises a plasma display panel 1, an X electrode driving circuit 2, a Y electrode driving circuit 3, an address electrode driving circuit (semiconductor integrated circuit device) 4, etc.

The plasma display panel 1 includes X electrodes 5, Y electrodes 6, and address electrodes 7. The X electrode driving circuit 2 outputs an X pulse to be applied to an X electrode 5 according to a driving pulse. The Y electrode driving circuit 3 outputs a Y pulse to be applied to a Y electrode according to a driving pulse.

The address electrode driving circuit 4 outputs an address pulse to be applied to an address electrode 7 according to display data. The display data includes, for example, image bit data, a latch signal, etc.

In this plasma display panel display device, one field obtained for a time is divided into eight sub-fields, each having a relative specific luminance different from those of others, for example, to obtain 256 gradation levels of colors (8 bits). The sub-fields are disposed sequentially from the least significant bit (LSB) to the most significant bit (MSB) in each object image bit information.

One sub-field consists of three types of periods; a reset period, an address period, and a sustained discharge period.

In the reset period, three operations of total screen erasing, total screen writing, and total screen erasing are executed sequentially. In the address period, image bit information that is one of display data items allocated to each of the sub-fields is written line by line sequentially. In an address electrode 7, image bit information of n lines equivalent to the number of display lines is output sequentially as serial data, beginning at the first line. At this time, in each address electrode, an address pulse is applied only to each discharge cell to be displayed selectively.

Scan pulses are applied to the Y electrodes 6 line by line sequentially, beginning at the first electrode of each line corresponding to the serial data to be applied to the address electrodes 7. The scan pulse changes the voltage to be applied to 0V in the same phase as that of the address pulse. Consequently, image bit information is written only while address pulses are applied to the address electrodes 7 and scan pulses are applied to the Y electrodes 6.

In the sustained discharge period, sustain pulses are applied to both of the Y electrodes 6 and X electrodes 5 alternately to sustain the discharging. At that time, while the voltage to be applied to the address electrodes 7 is fixed at 0V, discharging is done again only with the wall charges remaining in discharge cells in which image bit information is written respectively during an address period and the sustain pulses.

Next, a configuration of the address electrode driving circuit 4 will be described with reference to FIG. 2.

The address electrode driving circuit 4 is configured by, for example, one chip semiconductor integrated circuit device. More concretely, the address electrode driving circuit 4 is configured by a driving pulse generation circuit 9 and a plurality of address electrode driving parts (driving control parts) 10₁ to 10ₙ.

The address electrode driving parts 10₁ to 10ₙ are provided at a one-to-one correspondence to the X electrodes 5 provided in the plasma display panel 1. Consequently, the number of the address electrode driving parts 10₁ to 10ₙ are the same as the number of the X electrodes 5.

The address electrode driving part 10₁ is configured by a shift register 11, a latch 12, inverters 13 and 14, an output circuit (output part) 15, etc.

Image bit data (first data and second data) DATA included in display data is inputted to the data terminal D of the shift register 11 and a clock signal CLK is inputted to the clock terminal of the shift register 11.

The output terminal Q of the shift register 11 is connected to one of the data terminals D of the latch (first latch) 12. A latch signal is inputted to the other data (latch input) terminal LAT of this latch 12. The signal output from the output terminal Q of the latch 12 is inputted to the output circuit 15, as well as to the input part of the inverter 13 as a change-over signal (2nd change-over signal) INN.

The signal output from the output part of the inverter 13 is inputted to the output circuit 15 as an inverted change-over signal (1st change-over signal) /INP. The latch signal is also inputted to the driving pulse generation circuit 9 and the driving pulse generation circuit 9 generates pulses according to this latch signal.

The pulses output from the driving pulse generation circuit 9 are inputted to the input part of the inverter 14 and the signal output from the output part of the inverter 14 is inputted to the output circuit 15 as a driving pulse signal (driving pulse) /ACL. The output circuit 15 then outputs an address pulse D1.

While the configuration of the address electrode driving part 10₁ has been described above, the configuration is the same in each of other address driving parts 10₂ to 10ₙ, so that the description will be omitted here.

Next, a configuration of the output circuit 15 will be described with reference to FIG. 3.

The output circuit 15 is configured by transistors T1 to T11 and a Zener diode Z1. The transistors T1, T3, T5, T7 T8, and T10 are P-channel MOS transistors while the transistors T2, T9, T11 are N-channel MOS transistors. And, the transistors T4 and T6 are NPN-type bipolar transistors.

The transistors T1 and T2, as well as the transistors T8 and T9 are connected serially between a logic supply voltage (2nd supply voltage) V1 and a ground potential (reference potential) GND in an inverter configuration.

An inverted change-over signal /INP (FIG. 2) is inputted to the input part of each of the transistors T1 and T2 and the base of the transistor T6 is connected to the output part of each of the transistors T1 and T2.

A change-over signal INN (FIG. 2) is inputted to the input part of each of the transistors T8 and T9 and the gate of the transistor (pull-down element, driving part) T11 is connected to the output part of each of the transistors T8 and T9.

The high supply voltage (1st supply voltage) V2 is supplied to one of the connection parts of each of the transistors T3 and T5, as well as to the cathode of the Zener diode Z1 respectively. The other connection part of the transistor T3 is connected to the gate of each of the transistors T3 and T5, as well as to the collector of the transistor 4 respectively.

The other connection part of the transistor T5 is connected to the anode of the Zener diode Z1, the collector of the transistor T6, and the gate of the transistor (pull-up element, driving part) T10 respectively.

An inverted change-over signal /INP is inputted to the base of the transistor T4 and the emitter of the transistor T4 is connected to the emitter of the transistor T6 and one of the connection parts of the transistor T7 respectively.

A driving pulse signal /ACL (FIG. 2) is inputted to the gate of the transistor T7 and the other connection part of the transistor T7 is connected to the ground potential GND through a current supply circuit I1.

The transistors T3 to T7 and the Zener diode Z1 are combined to configure a level shift circuit.

The transistors T10 and T11 function as output drivers of push-pull circuits connected serially between the high supply voltage V2 and the ground potential GND, and the output part of each of the transistors T10 and T11 outputs an address pulse D1.

Next, the function of the address electrode driving circuit 4 in this embodiment will be described.

At first, the operation of the output circuit 15 will be described.

At first, in order to turn on the transistor T10 provided in the output driver to output the address pulse D1 as a High signal, the transistor T11 is turned off, the inverted change-over signal /INP is output as a Low signal, the transistor T4 is turned off, the transistor T6 is turned on, the driving pulse signal /ACL is output as a High signal, and the transistor T7 is turned on respectively to charge the parasitic capacity Cp1 of the transistor T10 through the transistor T6 and discharge the parasitic capacity Cp2.

If the threshold voltage of the transistor T9 is lower than the Zener voltage of the Zener diode Z1, no current flows in the Zener diode Z1 until charging/discharging of the parasitic capacity Cp1/Cp2 is completed.

When the charging/discharging of the parasitic capacity Cp1/Cp2 is completed, the address pulse D1 is driven by the transistor T10 to have the same potential as that of the high supply voltage V2, that is, to be output as a High signal.

If the current flowing is continued after the charging/discharging of the parasitic capacity Cp1/Cp2 is completed, an invalid current just flows in the Zener diode Z1. The transistor T7 is thus turned off to shut off the current.

At that time, the rising speed of the address pulse D1 is determined by the time of discharging of the parasitic capacity Cp2 of the current supply circuit I1, which flows through the transistor T7. If the load of the transistor T10 is within its drivability, the rising speed of the address pulse D1 is not affected by the load at all.

To turn off the transistor T10 provided in the output driver to output the address pulse D1 as a Low signal, the inverted change-over signal /INP is output as a High signal, the transistor T4 is turned on, the transistor T6 is turned off, and the driving pulse signal /ACL is output as a Low signal to turn off the transistor T7, thereby discharging the parasitic capacity Cp1 of the transistor T10. The transistor T10 is thus turned off.

Then, the transistor T11 is turned on to output the address pulse D1 as a Low signal.

In that connection, the parasitic capacity Cp2 is charged through the transistor T5, so that the transistor T5 must be kept on until the address pulse D1 comes to have the same potential as the ground potential GND. If the transistor T5 is turned off before charging of the parasitic capacity Cp2 is completed, the parasitic capacity Cp2 is charged from the parasitic capacity Cp1, thereby the transistor T10 comes to be turned on.

Because the current-driven level shift circuit is used in this way, the withstand voltage of the gate-source voltage Vgs of the transistor T10 is reduced significantly.

Next, the operation of the address electrode driving circuit 4 will be described with reference to the timing charts shown in FIGS. 2 and 4.

In FIG. 4, signal timings are shown from top to bottom sequentially in the order of the output of the shift register 11, the latch signal inputted to the address electrode driving circuit 4, the change-over signal INN output from the latch 12, the driving pulse /ACL output from the inverter 14, and the address pulse D1 output from the output circuit 15.

At first, the image bit data DATA inputted to the shift register 11 is shifted by the shift register 11 according to the clock signal (shift pulse) CLK, then output to the latch 12.

The latch 12 latches the data output from the shift register 11 according to a latch signal, then inputs the latched data to the output circuit 15 as a change-over signal INN. The change-over signal INN is inverted by the inverter 13, then inputted to the output circuit 15 as an inverted change-over signal /INP.

Similarly, the pulse generated by the driving pulse generation circuit 9 according to a latch signal is inverted by the inverter 14, then inputted to the output circuit 15 as a driving pulse /ACL.

According to the change-over signal INN, the inverted change-over signal /INP, and the driving pulse signal /ACL inputted to the output circuit 15 respectively, the output circuit 15 outputs an address pulse D1 as described above.

The address electrode driving circuit 4 comes to output driving pulses /ACL (pulses shaded in the driving pulse /ACL in FIG. 4) even when the shift register 11 outputs signals without changing the level, for example, from a High signal to a High signal or from a Low signal to a Low signal. The driving pulses /ACL output during this period in which the signal level remains the same are unnecessary pulses that cause the driving current to be consumed wastefully.

Next, a description will be made for the address electrode driving circuit (semiconductor integrated circuit device) 4a that can eliminate such unnecessary pulses and suppress wasteful driving current consumption with reference to FIG. 5.

Similarly to the address electrode driving circuit 4 shown in FIG. 2, the address electrode driving circuit 4a is configured by a driving pulse generation circuit 9, as well as a plurality of address electrode driving parts (driving control parts) 10a₁ to 10aₙ.

The circuit configuration of the address electrode driving part 10a₁ (to 10aₙ) is the same as that of the address electrode driving part 10₁ (to 10ₙ) in FIG. 2; it is configured by a shift register 11, a latch 12, an inverter 13, and an output circuit 15 and provided newly with a latch (2nd latch) 16, an inverter (driving pulse output part) 17, an exclusive OR-circuit (driving pulse output part) 18, and a NAND-circuit (driving pulse output part) 19.

The output terminal Q of the latch 12 is connected to the data terminal D of the latch 16 and one of the input parts of the exclusive OR-circuit 18 respectively. The output part of the driving pulse generation circuit 9 is connected to the input part of the inverter 17 and one of the inputs of the NAND-circuit 19 respectively.

The output part of the inverter 17 is connected to the latch input terminal LAT of the latch 16 while the other input part of the NAND-circuit 19 is connected to the output part of the exclusive OR-circuit 18. The signal output from the output part of the NAND-circuit 19 is inputted to the output circuit 15 as a driving pulse /ACL.

Other circuit connections are the same as those of the address electrode driving parts 10₁ (to 10ₙ) The description for them will thus be omitted here.

FIG. 6 shows a timing chart of each part signal in the address electrode driving circuit 4a.

In FIG. 6, the signal timings are shown from top to bottom sequentially in the order of the output of the shift register 11, the latch signal inputted to the address electrode driving circuit 4a, the change-over signal INN output from the latch 12, the driving pulse /ACL output from the NAND circuit 19, and the address pulse D1 output from the output circuit 15.

In the address electrode driving part 10a₁ (to 10aₙ), the newly provided latch 16 latches a preceding pulse output from the latch 12 and inputs the pulse to the exclusive OR-circuit 18 together with a new pulse output from the latch 12. The NAND-circuit 19 outputs a driving pulse /ACL only when both of the pulses are different from each other.

Consequently, the output of the driving pulse /ACL is suppressed as long as the shift register 11 outputs signals without changing the level, for example, from a High signal to a High signal or from a Low signal to a Low signal. Wasteful driving current consumption is thus prevented.

If the rate of the load current to the current consumption decreases, the effect of preventing such wasteful current consumption comes to appear significantly. And, the less the number of output change-over times becomes, the more significant the effect becomes.

In the address electrode driving circuit 4a, many screens, each of which has an on-time different from those of others, are put in layers so as to display images in gradation levels of colors, so that the number of output change-over times per screen decreases. This method is thus favorable.

As a screen becomes smaller in size, the load current decreases and the rate of the driving current to the current consumption increases. The effect of preventing wasteful current consumption thus increases.

After that, in the plasma display panel 1, the capacity between adjacent lines works as a main load and the timings of both rising and falling of a signal must be prevented from crossing each other between adjacent electrodes so as to suppress such a load current. And, upon an output change, the through-current that flows between the transistors T10 and T11 provided in the output circuit 15 (FIG. 3) must also be prevented.

FIG. 7 shows a block diagram of an address electrode driving circuit (semiconductor integrated circuit device) 4b that prevents such a through-current.

The address electrode driving circuit 4b is configured by a delay signal generation circuit 20, as well as a plurality of address electrode driving parts (driving control parts) 10b₁ to 10bₙ.

The delay signal generation part 20 is configured by a delay circuit 21, a falling delay circuit 22, an inverter 23, and a NAND-circuit 24. Each of the address electrode driving parts 10b₁ to 10bₙ is configured by a shift register 11 and a latch 12 just like the address electrode driving part shown in FIG. 2 and newly provided with a selector 25, an inverter 26, NAND-circuits 27 and 28, and an output circuit (output part) 15a.

In the output circuit 15a, the level shift circuit is formed not as a current-driven one but formed as a voltage-driven one that requires no driving pulse /ACL.

A latch signal is inputted to the input part of the delay circuit 21 and the other input part of the NAND-circuit 24 respectively. The output part of the delay circuit 21 is connected to the input part of the inverter 23 and the output part of the inverter 23 is connected to one of the input parts of the NAND-circuit 24.

The output part of the NAND-circuit 24 is connected to the input part of the falling delay circuit 22 and one of the inputs of the selector 25. The output part of the falling delay circuit 22 is connected to the other input part of the selector 25.

The delay signal generation part 20 generates delay signals DL1 and DL2 from latch signals, then outputs those signals DL1 and DL2 that are driven into the high impedance state (Hi-Z) for a period. The delay signal (1st delay signal) DL1 is shorter in the high impedance state (Hi-Z) than the delay signal (2nd delay signal) DL2.

In the address electrode driving part 10b₁ (to 10bₙ), the output terminal Q of the latch 12 is connected to the control terminal of the selector 25, the input part of the inverter 26, and the other input part of the NAND-circuit 27 respectively.

The output part of the selector 25 is connected to one of the inputs of each of the NAND-circuits 27 and 28 and the other input part of the NAND-circuit 28 is connected to the output part of the inverter 26.

The selector 25 selects one of the delay signals DL1 and DL2 inputted to both of the inputs of the selector 25 according to the control signal inputted to its control terminal and outputs the selected delay signal. In that connection, if the latch 12 outputs a High signal, the selector 25 selects the delay signal DL2. If the latch 12 outputs a Low signal, the selector 25 selects the delay signal DL1.

Then, the NAND-circuit 27 comes to output an inverted change-over signal /INP through the output part and the NAND-circuit 28 comes to output a change-over signal INN through the output part and both of the change-over signals /INP and INN are inputted to the output circuit 15a respectively.

FIG. 8 shows a timing chart of each part signal in the address electrode driving circuit 4b.

In FIG. 8, signal timings are shown from top to bottom sequentially in the order of the latch signal, the delay signal DL1, the delay signal DL2, and the address pulse D1 of the output circuit 15a.

In that connection, as shown in FIG. 8, the delay signal generation circuit 20 generates the delay signals DL1 and DL2 that are identical in falling timing and different in rising timing upon a latch signal input.

When the delay signals DL1 and DL2 fall, the output driver in the final step (ex., configured by P-channel MOS transistors and N-channel MOS transistors) of the output circuit 15a is turned off, thereby the signals DL1 and DL2 are driven into the high impedance state.

After that, the selector 25 selects a timing for resetting the high impedance state. At that time, if the latch 12 outputs a High signal, the selector 25 selects the delay signal DL2. If the latch 12 outputs a Low signal, the selector selects the delay signal DL1.

Because the high impedance state is reset when the selected delay signal DL1/DL2 rises, the signal rising/falling timing between adjacent electrodes can be shifted. In addition, because the latch output is shifted from the high impedance state, the through-current can be prevented.

As described above, because a timing for resetting the high impedance state can be selected according to the output data type, it is possible to select an output change-over timing to prevent rising and falling timings of a signal between adjacent electrodes from crossing each other.

Although a timing for resetting the high impedance state is selected to prevent rising and falling of a signal from crossing each other in FIG. 8, the crossing can also be prevented, for example, by inverting the connection of the output part of the selector 25.

FIG. 9 shows a block diagram of an address electrode driving circuit (semiconductor integrated circuit device) 4c that includes an output circuit 15 provided with the current-driven level shift circuit shown in FIG. 3 so as to select a timing for resetting the high impedance state, thereby selecting a timing for changing over the current output to another.

The address electrode driving circuit 4c is configured by a delay signal generation part 29, a Hi-Z driving pulse generation circuit (high impedance driving pulse generation part) 30, a falling delay circuit 31, driving pulse generation circuits 32 and 33, and a plurality of address electrode driving parts (driving control parts) 10c₁ to 10cₙ.

The delay signal generation circuit 29 is configured by an AND-circuit 34, a delay circuit 35, an inverter 36, and a NAND-circuit 37. The Hi-Z driving pulse generation circuit 30 is configured by inverters 38 and 39, a delay circuit 40, and an AND-circuit 41.

Each of the address electrode driving parts 10c₁ (to 10cₙ) is configured by a shift register 11, a latch 12, and the output circuit 15 shown in FIG. 3 just like that shown in FIG. 2 and newly provided with selectors 42 and 43, an inverter 44, NAND-circuits 45 and 46, and a NOR-circuit 47.

The high impedance control signal /Hi-Z is inputted to the input part of the inverter 38 and one of the input parts of the AND-circuit 34 respectively. The output part of the inverter 38 is connected to the input part of the delay circuit 40 and the other input part of the AND-circuit 41 respectively.

The output part of the delay circuit 40 is connected to the input part of the inverter 39 and the output part of the inverter 39 is connected to one of the input parts of the AND-circuit 41. The signal output from the AND-circuit 41 is inputted to one of the input parts of the NOR-circuit 47 as a driving pulse signal A3.

A latch signal is inputted to the other input part of the AND-circuit 34, and the output part of the AND-circuit 34 is connected to the input part of the delay circuit 35 and the other input part of the NAND-circuit 37 respectively.

The output part of the delay circuit 35 is connected to the input part of the inverter 36, and the output part of the inverter 36 is connected to one of the input parts of the NAND-circuit 37.

The output part of the NAND-circuit 37 is connected to the input part of the falling delay circuit 31 and one of the input parts of the AND-circuit 48. The output part of the AND-circuit 48 is connected to the input part of the driving pulse generation circuit (1st driving pulse generation part) 32 and one of the input parts of the selector (1st selector) 42 respectively. This NAND-circuit 37 comes to output the delay signal DL1.

The output part of the falling delay circuit 31 is connected to one of the input parts of the AND-circuit 49. The output part of the AND-circuit 49 is connected to the input part of the driving pulse generation circuit (2nd driving pulse generation part) 33 and the other input part of the selector 42 respectively. This falling delay circuit 31 comes to output the delay signal DL2. The high impedance control signal /Hi-Z is inputted to the other input part of each of the AND-circuits 48 and 49.

The output part of the driving pulse generation circuit 32 is connected to one of the input parts of the selector (2nd selector) 43, and the output part of the driving pulse generation circuit 33 is connected to the other input part of the selector 43. Those driving pulse generation circuits 32 and 33 come to output the driving pulse signals A1 and A2.

The output terminal Q of the latch 12 is connected to the control terminal of each of the selectors 42 and 43, the input part of the inverter 44, and the other input part of the NAND-circuit 45 respectively.

The output part of the selector 42 is connected to one of the input parts of each of the NAND-circuits 45 and 46 and the output part of the inverter 44 is connected to the other connection part of the NAND-circuit 46.

These NAND-circuits 45 and 46 come to output the inverted change-over signal /INP and the change-over signal INN to the output circuit 15 respectively.

The output part of the selector 43 is connected to the other input part of the NOR-circuit 47 and the NOR-circuit 47 comes to output the driving pulse signal /ACL to the output circuit 15.

FIG. 10 shows a timing chart of each part signal in the address electrode driving circuit 4c.

In FIG. 10, signal timings are shown from top to bottom sequentially in the order of the latch signal, the high impedance control signal /Hi-Z, the delay signal DL1, the driving pulse signal A1, the delay signal DL2, the driving pulse signal A2, the driving pulse signal A3, and the output of the output circuit 15.

As shown in FIG. 10, in the Hi-Z driving pulse generation circuit 30, the output of the output circuit 15 is driven into the high impedance state when the level of the high impedance control signal /Hi-Z is low. At that time, the Hi-Z driving pulse generation circuit 30 applies a driving pulse to the P-channel MOS transistor T10 to turn it off. The transistor T10 is included in the output driver of the output circuit 15 (FIG. 3).

This pulse just discharges only the parasitic capacity Cp1 of the transistor T10, so that the pulse is not required to be so long to change over the output state.

When changing over an output state, the selector 43 selects either the driving pulse signal A1 or A2 corresponding to the delay signal DL1 or DL2 to be used as a change-over timing.

An output timing is selected according to the output state of the latch 12 when the high impedance state is reset even after the high impedance state of the latch 12 set by the high impedance control signal Hi-Z is rewritten.

The output of the driving pulse /ACL may be stopped to suppress wasteful driving current consumption if the shift register 11 outputs signals without changing the signal level as shown in FIG. 5, for example, from a High signal to a High signal or from a Low signal to a Low signal in the address electrode driving circuit 4c.

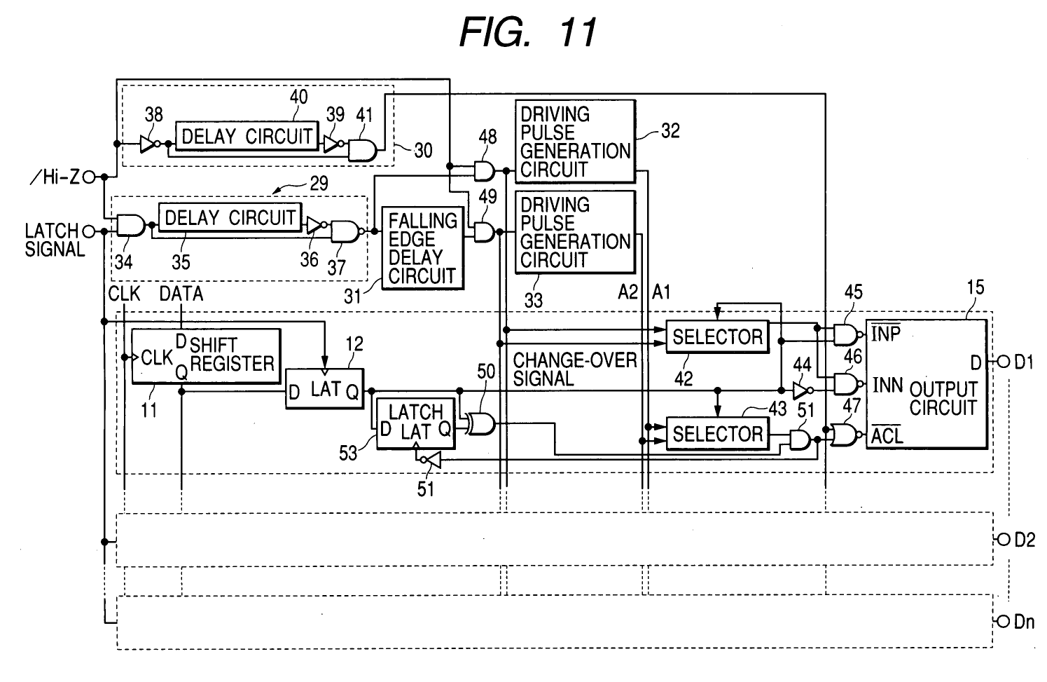

In that connection, as shown in FIG. 11, the address electrode driving circuit 4c is configured similarly to the address electrode driving part 10c₁ (to 10cₙ) shown in FIG. 9; concretely, the circuit 4c is configured by a shift register 11, a latch 12, an output circuit 15, selectors 42 and 43, an inverter 44, NAND-circuits 45 and 46, a NOR-circuit 47, another latch (2nd latch) 53, another inverter (driving pulse output part) 51, an exclusive OR-circuit (driving pulse output part) 50, and an AND-circuit (driving pulse output part) 52. In this case, the circuit 4c is also provided newly with a Hi-Z resetting driving pulse generation circuit 55 for receiving the output of the AND-circuit 49, as well as an AND-circuit 54 that connects the output of the Hi-Z resetting driving pulse generation circuit 55 through one of its inputs and connects the output of the AND-circuit 49 through the other input and has an output used as a Hi-Z control line A3. The Hi-Z resetting driving pulse generation circuit 55 is configured by an inverter 57, a delay circuit 58, and an AND-circuit 56.

Even in that case, as shown in FIG. 5, the output of the driving pulse /ACL is suppressed, since the shift register 11 outputs signals without changing the signal level, for example, from a High signal to a High signal or from a Low signal to a Low signal even at an output state change due to a latch signal. Consequently, wasteful driving current consumption is prevented.

Furthermore, even if the state of the internal latch 12 is changed over when the signal /Hi-Z is High in level and the state of the latch 12 is changed over to the high impedance state or already set in the high impedance state, the output timing of the latch 12 comes to be selected according to its output state when the high impedance state is reset as shown in FIG. 9.

If the internal latch 12 remains in the same state and outputs High signals when the high impedance state is reset, a driving pulse is required to be applied to the P-channel MOS transistor T10 that configures the output driver of the output circuit 15 (FIG. 3) so that the transistor T10 is turned on.

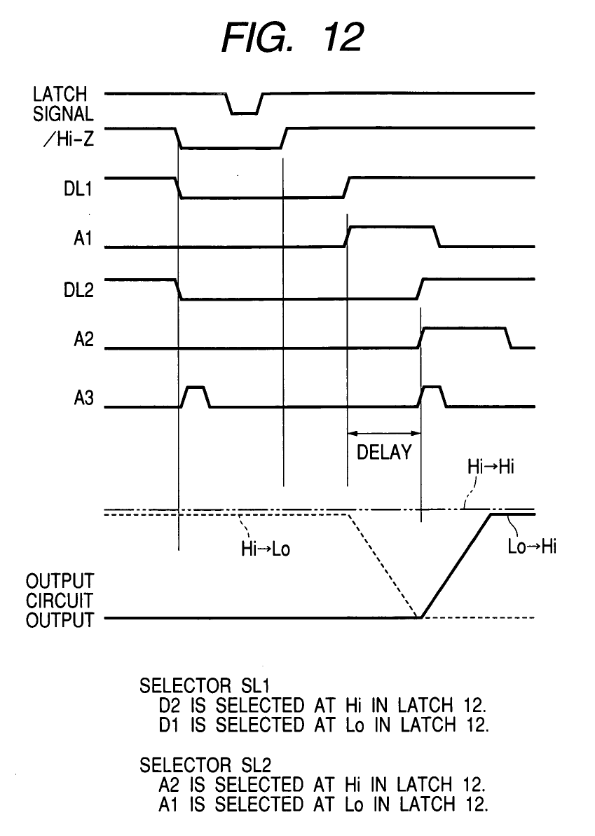

This pulse just charges only the parasitic capacity Cp1 of the transistor T10, so that the pulse is not required to be so long to change over the output state. FIG. 12 shows a timing chart of each part signal shown in FIG. 11.

In that connection, because no output state change-over occurs, the driving pulse of the driving pulse signal A2 comes to be masked by the exclusive OR-circuit 50. This is why the output is reset from the high impedance state to the Hi state with use of a driving pulse output from the H-Z resetting driving pulse generation circuit 55 when the delay signal DL2 falls.

Therefore, the driving current for driving the semiconductor integrated circuit device of the present invention can be minimized.

Consequently, in this embodiment, because transistors, each having a small withstand gate-source voltage Vgs, can be used for the output driver of the output circuit 15, it is possible to reduce the size of the output driver and realize high drivability.

And, because the output driver through-current is prevented, the power consumption of the address electrode driving circuit 4 can be reduced.

While the preferred form of the present invention has been described concretely, it is to be understood that modifications will be apparent to those skilled in the art without departing from the spirit of the invention.

The effects to be obtained by the typical objects of the present invention disclosed in this specification will be described briefly as follows.

(1) Because the output driver of the output part is reduced in size, the drivability is improved and the semiconductor integrated circuit device can be reduced in size.

(2) Because the through-current of the output driver is prevented, the power consumption of the semiconductor integrated circuit device is reduced.

(3) Furthermore, the display device can be reduced in both of size and power consumption due to the effects described in (1) and (2).

What is claimed is:

1. A semiconductor integrated circuit device for driving an address electrode of a display device according to display data,
wherein said semiconductor integrated circuit device includes a drive control part that includes:
an output part for outputting an electrode driving pulse for driving said address electrode of said display device according to a first change-over signal, a second change-over signal, and a driving pulse; and
an output driving part for driving said output part according to said display data,
wherein said output driving part outputs the driving pulse for driving said output part when said first data inputted first and said second data inputted after the input of said first data come to change both of said first and second data being included in said display data.

2. The semiconductor integrated circuit device according to claim 1,
wherein said output driving part includes:
a driving pulse generation part for generating a driving pulse from a latch signal;
a shift register for shifting inputted display data according to a shift pulse, then outputting said shifted display data;
a first latch for latching display data output from said shift register according to the latch signal;
a second latch for latching display data output from said first latch according to the driving pulse; and
a driving pulse output part for comparing said first data output from said first latch with said second data output from said second latch, then outputs the driving pulse to said output part when said first data does not match with said second data.

3. The semiconductor integrated circuit device according to claim 1,
wherein said output part includes:
an output circuit including a push-pull circuit in which first and second transistors are coupled serially between a first supply voltage and a reference potential;
a level shift circuit including a differential amplification circuit driven by said first supply voltage and the level shift circuit driving said first transistor that is a pull-up element of said output circuit according to said first change-over signal and said driving pulse; and
a driving part driven by a second supply voltage having a voltage value lower than that of said first supply voltage and the driving part driving said second transistor that is a pull-down element of said output circuit according to said second change-over signal.

4. A semiconductor integrated circuit device for driving an address electrode of a display device according to display data,
wherein said semiconductor integrated circuit device includes a driving control part that includes an output part for outputting an electrode driving pulse for driving said address electrode of said display device and an output driving part for driving said output part according to said display data, and
wherein said output driving part converts the output of said output part into a high impedance state according to a high impedance control signal when an output state of said output part is changed over.

5. The semiconductor integrated circuit device according to claim 4,
wherein said output driving part includes:
a shift register for shifting inputted display data according to a shift pulse, then outputting the shifted display data; and
a first latch for latching display data output from said shift register according to a latch signal; and
wherein said driving control part includes:
a signal generation part for generating first and second delay signals of which timings are different from each other according to latch signals;
a first driving pulse generation part for generating a first driving pulse according to the first delay signal output from said signal generation part;
a second driving pulse generation part for generating a second driving pulse according to the second delay signal output from said signal generation part;
a first selector for selecting either said first delay signal or second delay signal output from said signal generation part according to an output signal output from said first latch and the first selector for outputting the selected delay signal as a first or second change-over signal; and
a second selector for selecting one of said first and second driving pulses output from said first and second driving pulse generation parts according to an output signal output from said first latch and the second selector for outputting the selected driving pulse as a driving pulse.

6. The semiconductor integrated circuit device according to claim 4,
wherein said output driving part outputs the driving pulse for driving said output part when first data inputted first and second data inputted after the input of said first data come to change both of said first and second data being included in said display data.

7. The semiconductor integrated circuit device according to claims 4,
wherein said output part includes:
an output circuit that includes a push-pull circuit in which first and second transistors are coupled serially between a first supply voltage and a reference potential;
a level shift circuit that includes a differential amplification circuit driven by said first supply voltage and the level shift circuit driving said first transistor that is a pull-up element of said output circuit according to said first change-over signal and said first or second driving pulse selected by said second selector; and
a driving part driven by a second supply voltage having a voltage value lower than that of said first supply voltage and the driving part driving said second transistor that is a pull-down element of said output circuit according to said second change-over signal.
